(19) United States
(12) Patent Application Publication
(10) Pub. No.: US 2008/0094745 A1
(43) Pub. Date: Apr. 24, 2008

(54) Playback equipment and supplying method in playback equipment

(75) Inventor: Hideyuki Iketani, Sayama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,154

(22) Filed: Oct. 22, 2007

(30) Foreign Application Priority Data
Oct. 23, 2006 (JP) 2006-287970

(51) Int. Cl. G11B 5/02

(52) U.S. Cl. 360/55

(57) ABSTRACT

According to one embodiment, a playback equipment includes a recording section which records information on a magnetic disc C, a motor which rotates the magnetic disc, a nonvolatile memory B which stores information in a recording area, a display section which displays the information on a screen, a playback section which performs a playback process in response to the above information, and a control section which increases speed of the motor in a stepwise fashion and supplies the information stored in the nonvolatile memory to the display section or playback section in a preset period of time after an operation signal from an operating section is received and controls the motor to rotate at constant speed after the preset period of time has elapsed.

### CROSS-REFERENCE TO RELATED APPLICATIONS

This application is based upon and claims the benefit of priority from Japanese Patent Application No. 2006-287970, filed Oct. 23, 2006, the entire contents of which are incorporated herein by reference.

### BACKGROUND

1. Field

One embodiment of the present invention relates to a playback equipment using a hard disc driver or the like and an information supplying method in the playback equipment.

2. Description of the Related Art

Recently, playback equipments which manages musical sources by use of digital files and play back the same are developed and popularly used with the development of the digital technology. Since the playback equipment containing a portable hard disc driver (HDD) performs the playback operation by use of a built-in battery, the operable time thereof is determined by the capacity of the battery of the terminal.

In a musical player using the HDD, a system which stores necessary data in a memory of the terminal and turns ON the power supply of the HDD only at the data transfer time to extend the terminal operating time is provided. However, if the threshold value of the battery using range is not set higher than the battery serviceable range, a voltage drop due to a rapid increase in the current at the operation start time occurs when the power supply of the HDD is turned ON for data transfer and the power supply voltage of the terminal is lowered.

In Patent Document 1 (Jpn. Pat. Appln. KOKAI Publication, No. H05-282770), a playback equipment is disclosed which is a magnetic disc playback equipment and makes it possible to efficiently drive a motor as a whole by suppressing a supply current at the operation start time.

However, in the conventional technique disclosed in the Patent Document 1, since the supply current at the operation start time is adequately suppressed, the magnetic disc cannot be instantly used immediately after the power supply switch is turned ON. Therefore, image data for display and musical data from the magnetic disc cannot be instantly supplied. As a result, there occurs a problem that the music cannot be instantly played back, an image of the operation display is not instantly displayed and waiting time of several seconds occurs when the power supply switch is turned ON.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the configuration of a playback equipment according to one embodiment of this invention.

FIG. 2 is an external view showing one example of the external appearance of the playback equipment according to one embodiment of this invention.

FIG. 3 is a timing chart for illustrating one example of the operation of the playback equipment according to one embodiment of this invention.

FIG. 4 is a graph showing one example of variations in the voltage value and current value of the playback equipment when the stepwise speed control operation is not performed.

FIG. 5 is a flowchart for illustrating one example of a data reading process of the playback equipment according to one embodiment of this invention.

FIG. 6 is a flowchart for illustrating one example of the data reading process of the playback equipment according to one embodiment of this invention.

### DETAILED DESCRIPTION

Various embodiments according to the invention will be described hereinafter with reference to the accompanying drawings. In general, according to one embodiment of the invention, a playback equipment comprising:

a recording section which records information on a magnetic disc;

a motor which rotates the magnetic disc;

a nonvolatile memory which stores information in a recording area;

a display section which displays the information on a screen;

a playback section which performs a playback process in response to the above information; and a control section which increases speed of the motor in a stepwise fashion and supplies the information stored in the nonvolatile memory to one of the display section and playback section in a preset period of time after an operation signal from an operating section is received and controls the motor to rotate at constant speed after the preset period of time has elapsed.

According to one embodiment of this invention, a playback equipment and a supplying method for the playback equipment are provided which can simultaneously attain start-up of the operation of a hard disc driver and the long service life of a battery.

According to one aspect of this invention, there is provided a playback equipment which includes a recording section (20, 21, 22) which records information on a magnetic disc (C: 20), a motor (21) which rotates the magnetic disc, a nonvolatile memory (B: 19) which stores information in a recording area, a display section (11) which displays the information on a screen, a playback section (25) which performs a playback process in response to the above information, and a control section (13, 24) which increases speed of the motor (21) in a stepwise fashion and supplies the information stored in the nonvolatile memory to the display section or playback section in a preset period of time (T1) after an operation signal from an operating section (13) is received and controls the motor to rotate at constant speed after the preset period of time has elapsed.

As a result, in a playback equipment having a hard disc driver or the like, a playback equipment and a supplying method for the playback equipment are provided which can simultaneously attain start-up of the operation of the hard disc driver and the long service life of a battery.

Next, one embodiment of this invention is explained in detail with reference to the accompanying drawings.

<Playback Equipment According to One Embodiment of this Invention>

(Configuration)

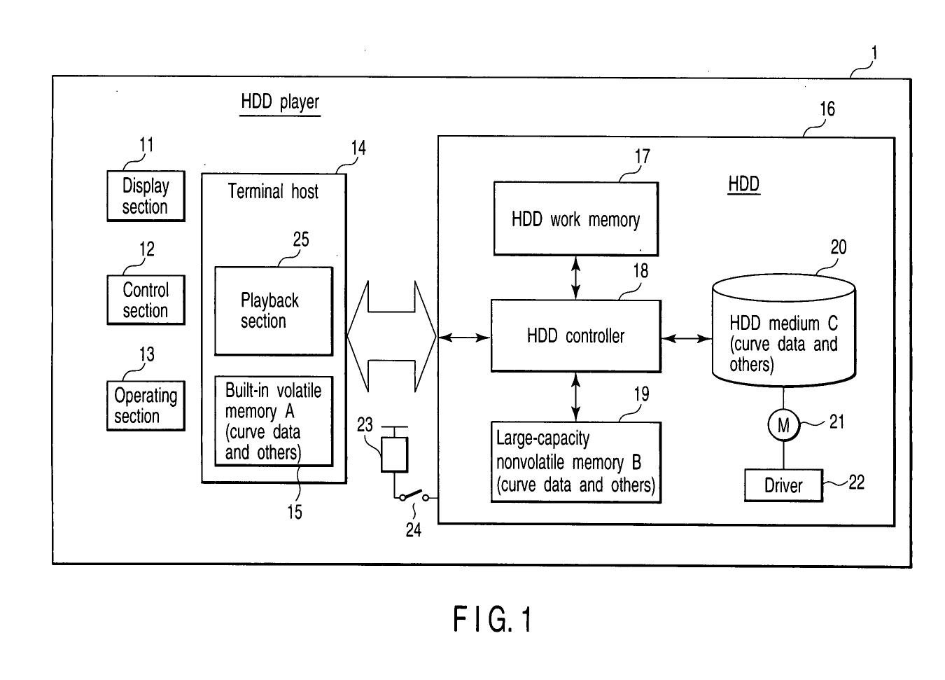

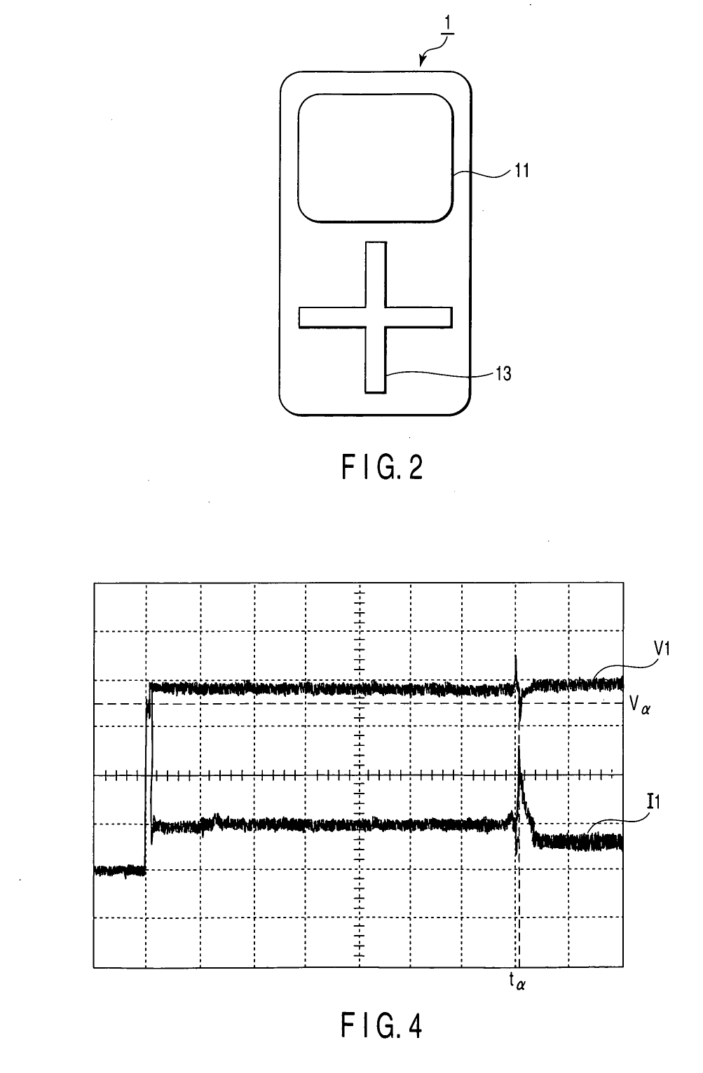

First, the configuration and operation of a playback equipment according to one embodiment of this invention are explained with reference to the accompanying drawings. FIG. 1 is a block diagram showing one example of the configuration of the playback equipment according to one embodiment of this invention. FIG. 2 is an external view showing one example of the external appearance of the playback equipment according to one embodiment of this invention. As shown in FIG. 1, one example of the playback equipment according to one embodiment of this invention is an HDD player 1 which can decode and play back a voice file (and a moving image file or the like) and is mainly configured by an HDD (Hard Disc Driver) section 16 and terminal host section 14.

That is, as shown in FIGS. 1 and 2, the playback equipment 1 includes a display section 11 which displays an operation screen and curve information items by use of a liquid crystal display or the like, a control section 12 which controls the operation of the whole portion, an operating section 13 which includes a power supply switch, various operation switches, a jog dial used for selection of music and the like, a playback section 25 which is contained in the terminal host 14 and plays back a voice file such as an MP3 file or the like by use of an MPEG decoder or the like, and a volatile memory 15 which is contained in the terminal host 14 and stores a voice file and moving image file, image information, various management information items and the like. Further, the playback equipment 1 includes an HDD 16 which drives a magnetic disc, a HDD work memory 17 which performs an extension process and the like, an HDD controller 18 which retrieves and controls an HDD, a large-capacity nonvolatile memory 19 which stores a voice file, moving image file and the like from an HDD medium 20, the HDD medium 20 which is a magnetic disc to store various digital data items, an HDD motor 21 which rotates the magnetic disc at preset speed, an HDD motor driver 22 which supplies a drive current used to drive the HDD motor 21, a battery section 23 which supplies power supply potential to at least the HDD section 16, and a switch section 24 which supplies power supply potential particularly from the battery section 23 to the HDD section 16.

(Basic Operation)

The above playback equipment 1 plays back a voice file and the like according to the basic operation as described below. A voice file and image information such as an MP3 file (as one example) stored in the HDD medium 20 contained in the HDD section 16 according to an address specified by the present management information are transferred to the built-in volatile memory 15 or the like under the control of the control section 12 according to the operations of playback and selection of music and the power supply switch of the operating section 13 by the user.

That is, as one example, when data is transferred from the HDD section 16 to the volatile memory 15 or the like of the terminal host, the data is transferred to the volatile memory 15 and a stop command used to stop supply of power of the HDD at the time of completion of transfer and data required when the HDD is next started are notified from the control section 12 to the HDD controller 18 in the HDD section 16.

The controller 18 on the HDD side which has received the notification transfers data required for next transfer to the nonvolatile memory 19 provided therein and sets the HDD medium C into the stop state immediately after completion of transfer. Further, supply of power of the HDD section 16 from the terminal host 14 is temporarily stopped by use of the switch 24.

Further, the control section 12 extracts voice information (moving image information, still image information and the like) stored in the volatile memory 15 and the like, performs the extending process and performs the demodulating process by use of the MPEG decoder function by the playback section 25 to output a played-back voice signal to an external terminal (not shown).

In addition, the control section 12 turns ON the power supply switch of the HDD section 16 again before data items of the volatile memory 15 and the like are used up according to an operation signal by the playback operation of the operating section 13 by the user, requests the HDD section 16 to transfer data and then performs the succeeding data transfer process and playback process.

<Data Reading Process for Preventing Voltage Drop at HDD Starting Time>

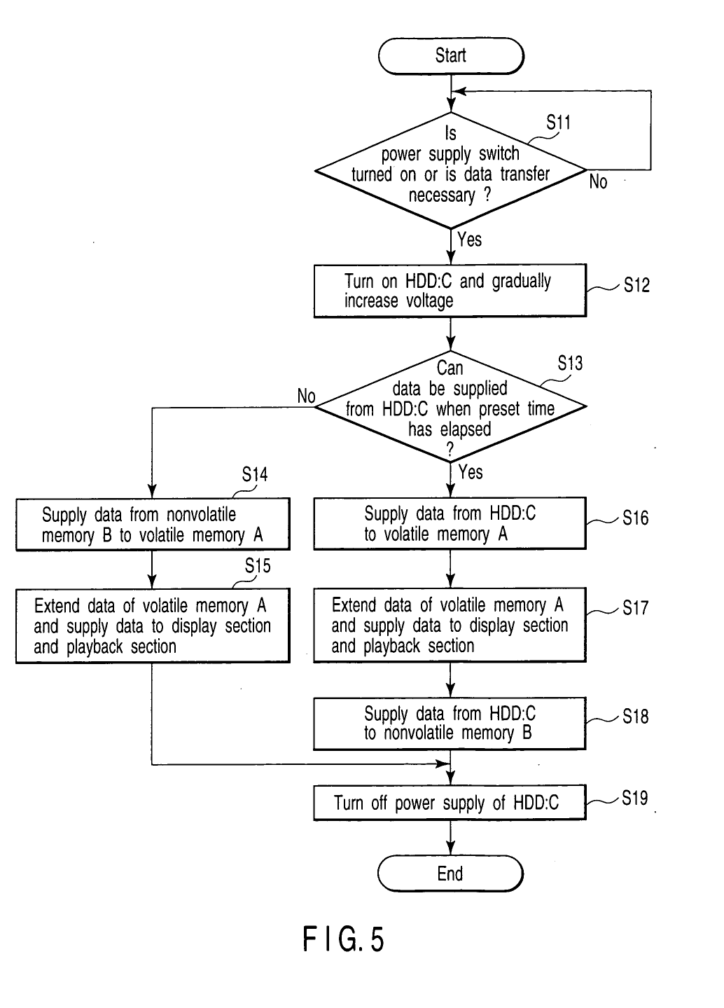

Data Reading Process According to Flowchart of FIG. 5

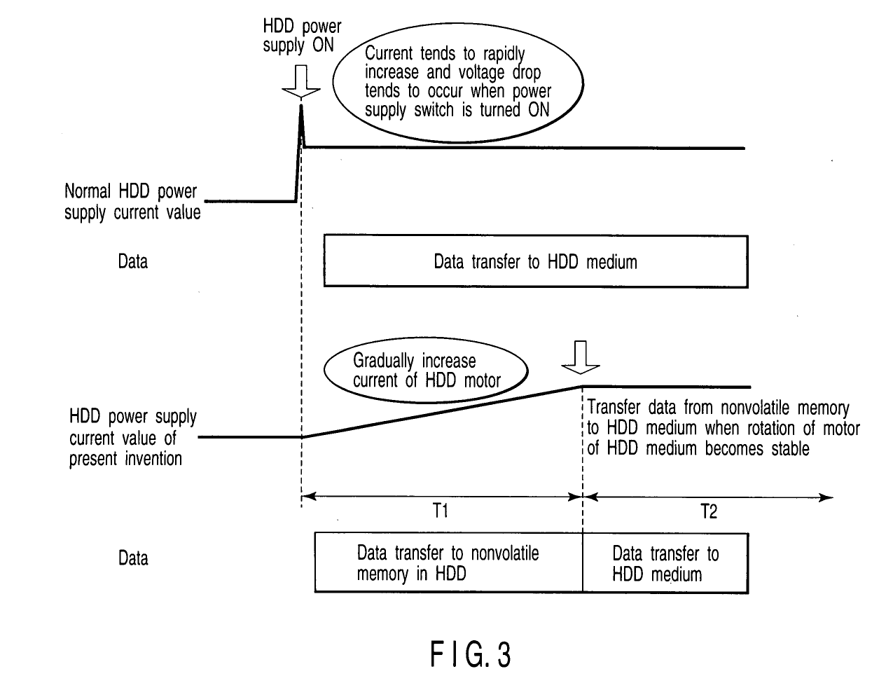

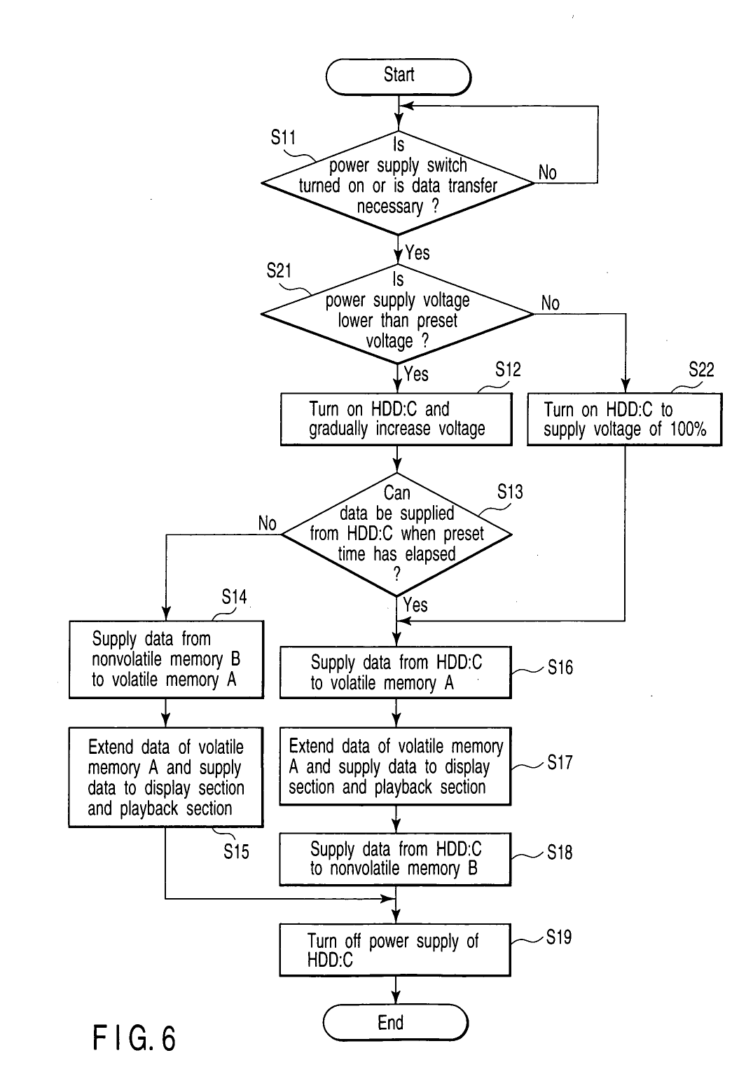

Next, one example of the data reading process for preventing a voltage drop at the HDD starting time in the above playback equipment is explained in detail by use of the flowchart. FIG. 3 is a timing chart for illustrating one example of the operation of the playback equipment according to one embodiment of this invention. FIG. 4 is a graph showing one example of variations in the voltage value and current value of the playback equipment when the stepwise speed control operation is not performed. FIGS. 5 and 6 are flowcharts for illustrating examples of the data reading process of the playback equipment according to one embodiment of this invention.

The steps in the flowcharts of FIGS. 5 and 6 can be replaced by circuit blocks and all of the steps of the flowcharts can be re-defined as blocks.

First, in the playback equipment 1, it is determined under the control of the control section 12 whether or not the power supply switch (not shown) of the operating section 13 of the user is turned ON or data transfer is required (step S11). That is, it is determined not only whether or not the power supply switch is turned ON but also whether or not data transfer is required when the voice file stored in the volatile memory 15 becomes insufficient or the user depresses the playback switch while the HDD medium 20 is being stopped after the required data transfer is completed as described before.

The control section 12 detects that the power supply switch is turned ON or that data transfer becomes necessary because the voice file stored in the volatile memory 15 becomes insufficient. Then, it increases the drive current to the motor 21 in a stepwise fashion by adjusting the drive current of the driver 22 during a preset period of time T1 as shown in FIG. 3 (step S12).

Thus, a lowering in the power supply voltage V₁ based on a rapid increase in the consumption current I₁ at time t_{α} as shown in FIG. 4 can be prevented. In the case of FIG. 4, since the power supply voltage is lowered to exceed a voltage threshold value V_{α} due to a rapid lowering in the power supply voltage V₁, it is determined that the battery section 23 is used up and the operation is stopped.

The data reading process for preventing occurrence of the voltage lowering at the HDD starting time in one embodiment of this invention prevents occurrence of the above problem. Specifically, both of the starting of the operation of the hard disc driver and the long service life of the battery can be simultaneously attained by increasing the drive current supplied to the motor 21 in a stepwise fashion by the operation of the control section 21 to prevent a rapid lowering in the power supply voltage of the battery section 23.

Next, the transfer process of data (voice file, moving image file, still image file, management information and the like) from the nonvolatile memory B19 to the volatile memory A15 is performed during the period of time T1 under the control of the control section 12 (step S14). Then, data of the volatile memory A15 is subjected to the extending process under the control of the control section 12 and data (voice file, moving image file, still image file, management information and the like) is supplied to the display section 11 and playback section 25 (step S15).

As a result, for example, even when the HDD medium 20 is not rotated at a sufficiently high rotation speed immediately after the power supply switch is turned ON, a menu screen or the like can be instantly displayed on the display section 11 based on still image information or the like supplied from the nonvolatile memory B19.

Further, if it is determined in the step S13 that the preset time T has elapsed, it becomes possible to supply data from the HDD medium 20. As a result, data is supplied from the HDD medium 20 to the volatile memory A15 under the control of the control section 12 (step S16). Further, data of the volatile memory A15 is extended and then supplied to the display section 11 and/or playback section 25 (step S17). After this, data is supplied from the HDD medium 20 to the nonvolatile memory B19 as required (step S18). Next, the power supply switch of the HDD section 16 is turned OFF according to the condition such as elapse of the set time or the like (step S19).

The flowcharts shown in FIGS. 5 and 6 are sub-routines which are normally repeated and whether or not the HDD medium 20 is required to be started is monitored by the control section 12.

Thus, a playback equipment is realized which can simultaneously attain both of the long service life of the battery and starting of the operation of the hard disc driver by increasing the rotation speed of the HDD medium 20 in a stepwise fashion to prevent occurrence of a rapid lowering in the power supply voltage at the HDD start time.

Data Reading Process According to Flowchart of FIG. 6

Further, it is also preferable to perform the above data reading process only when the power supply voltage of the battery section 23 is lower than a preset value instead of normally performing the process. The explanation for the steps in the flowchart of FIG. 6 which are the same as the steps of the flowchart of FIG. 5 is omitted and only different steps are explained.

That is, in the step S21, only when the power supply voltage of the battery section 23 is lower than a preset value, the process after the step S12 is performed. In the step S21, if the power supply voltage of the battery section 23 is set at sufficiently high voltage, the drive current of 100% is supplied from the driver 22 to the motor 21 to instantly set the rotation speed of the HDD medium 20 to a value of 100% (step S22). After this, necessary data can be read out from the HDD medium and supplied to the display section 11 and playback section 25 via the volatile memory A15 by performing the process following after the step S16. Thus, when the power supply voltage of the battery section 23 is set at sufficiently high voltage, a stable display process and playback process can be performed even if necessary data is not stored in the nonvolatile memory B19.

According to the various embodiments described above, the person in the art can realize the invention. However, it is easy for the person in the art to think out various modifications of the above embodiments and those who have no inventive ability can apply this invention to various embodiments. Therefore, this invention extends to a wide range which is not inconsistent with the principle disclosed and the novel feature and is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback equipment comprising:
a recording section which records information on a magnetic disc;
a motor which rotates the magnetic disc;
a nonvolatile memory which stores information in a recording area;
a display section which displays the information on a screen;
a playback section which performs a playback process in response to the above information; and
a control section which increases speed of the motor in a stepwise fashion and supplies the information stored in the nonvolatile memory to one of the display section and playback section in a preset period of time after an operation signal from an operating section is received and controls the motor to rotate at constant speed after the preset period of time has elapsed.

2. The playback equipment according to claim 1, further comprising a volatile memory,
wherein the control section performs a control operation to copy the information stored in the nonvolatile memory into the volatile memory and supply the information from the volatile memory to the playback section.

3. The playback equipment according to claim 1, wherein the control section increases the speed of the motor in a stepwise fashion in a preset period of time after an operation signal from the operating section is received only when power supply voltage of a power supply section which supplies the power supply voltage to the motor is set lower than preset voltage.

4. A supplying method for a playback equipment which includes a recording section which records information on a magnetic disc, a motor which rotates the magnetic disc, a nonvolatile memory which stores information in a recording area, a display section which displays the information on a screen and a playback section which performs a playback process in response to the above information, comprising:
increasing speed of the motor in a stepwise fashion and supplying the information stored in the nonvolatile memory to one of the display section and playback section in a preset period of time after an operation signal from an operating section is received; and
controlling the motor to rotate at constant speed after the preset period of time has elapsed.

5. The supply method according to claim 4, further comprising using a volatile memory, copying the information stored in the nonvolatile memory into the volatile memory and supplying the information from the volatile memory to the playback section.

6. The supply method according to claim 4, wherein the speed of the motor is increased in a stepwise fashion in a preset period of time after an operation signal from the operating section is received only when power supply voltage of a power supply section which supplies the power supply voltage to the motor is set lower than preset voltage.
